(19) United States
(12) Patent Application Publication
(10) Pub. No.: US 2012/0053971 A1
(43) Pub. Date: Mar. 1, 2012

(54) BUSINESS PROCESS REALIZATION LINKING

(75) Inventors: Hallgrim Ludvigsen, Stavanger (NO); Philip Richard Hodgson, Stavanger (NO); Alexander Martin Wilson, London (GB)

(73) Assignee: SCHLUMBERGER TECHNOLOGY CORPORATION, HOUSTON, TX (US)

(21) Appl. No.: 13/034,964

(22) Filed: Feb. 25, 2011

Related U.S. Application Data
(60) Provisional application No. 61/345,258, filed on May 17, 2010.

(51) Int. Cl. G06Q 10/06; G06F 17/30

(52) U.S. Cl. 705/7.11; 707/758; 707/E17.009

(57) ABSTRACT

One or more computer-readable media including computer-executable instructions to instruct a computing system to access a template, instantiate the template for a realization of a data-driven application, perform an analysis defined by the template where the analysis relies on linking to at least some data relied on by the data-driven application and output information based at least in part on the analysis. Various other apparatuses, systems, methods, etc., are also disclosed.

### RELATED APPLICATIONS

This application claims the benefit of U.S. Provisional Application having Ser. No. 61/345,258 entitled “Business Process Realization Linking,” filed May 17, 2010, which is incorporated by reference herein.

### BACKGROUND

Data within geoscience repositories are often important constituents of business decisions. For example, a business decision may depend on volume of recoverable oil, which inherently relies on physical data and potentially simulation results (e.g., from simulation of a geologic environment). In such an example, business decision making may be performed, at least in part, on paper. Further, documentation of business process decisions may rely on storing papers in a file, for example, with printouts of some relevant simulation results and possibly some physical data. Such practices do not readily provide for uniform decision making or reassessments of business decisions (or business decision making processes). As described herein, various techniques can optionally enhance decision making and analysis of decisions and decision making processes.

### SUMMARY

One or more computer-readable media including computer-executable instructions to instruct a computing system to access a template, instantiate the template for a realization of a data-driven application, perform an analysis defined by the template where the analysis relies on linking to at least some data relied on by the data-driven application and output information based at least in part on the analysis. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating a reservoir and components for a template-based analysis;

FIG. 2 illustrates an example of a framework that includes a model simulation layer and associated domain objects;

FIG. 3 illustrates examples of scenarios for a conventional business analysis and a template-based business analysis;

FIG. 4 illustrates examples of a template-based business analysis at two different times;

FIG. 5 illustrates an example of a method for performing a template-based analysis;

FIG. 6 illustrates examples of graphical user interfaces (GUIs) that provides for linking to entities and showing tagged entities;

FIG. 7 illustrates examples of GUIs that present information as to entities of a geoscience application;

FIG. 8 illustrates various components that may optionally be implemented in a system, for example, such as the systems of FIG. 1 or FIG. 3, along with a block diagram of an example of a method; and

FIG. 9 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

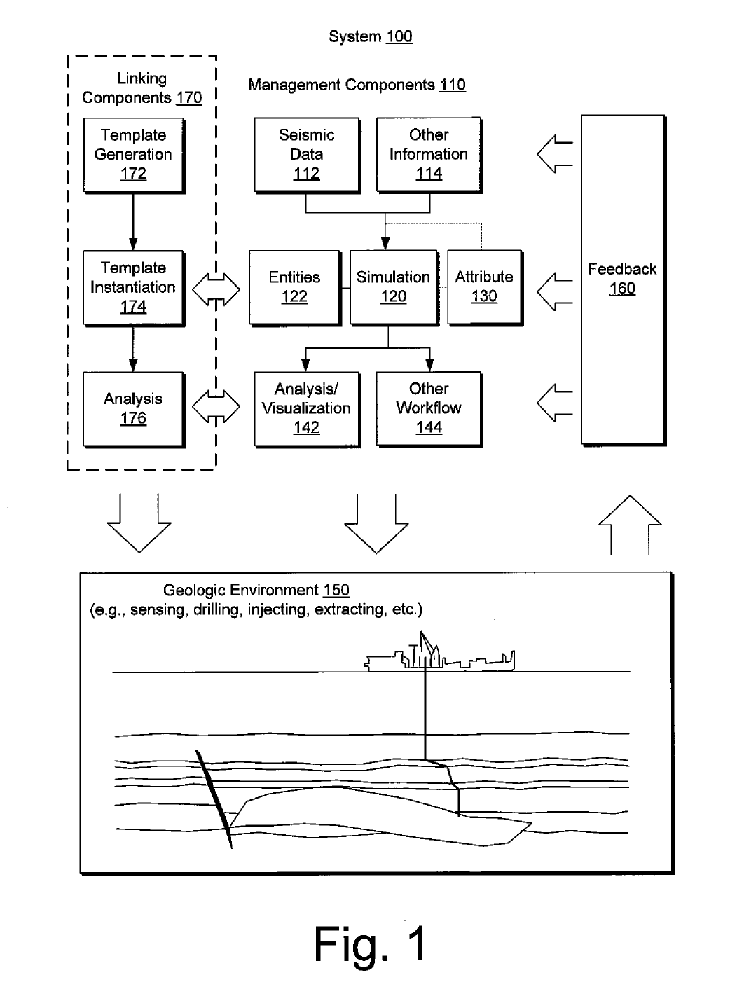

FIG. 1 shows an example of a system 100 that includes various management components 110 to manage various aspects of a geologic environment 150. For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110). Various linking components 170 are also shown that allow for integration of one or more particular processes that may rely on data or other information associated with the management components 110.

In the example of FIG. 1, the management components 110 include a seismic data component 112, an information component 114, a processing component 116, a simulation component 120, an attribute component 130, an analysis/visualization component 142 and a workflow component 144. In operation, seismic data and other information provided per the components 112 and 114 may be input to the simulation component 120.

As described herein, the simulation component 120 may rely on entities 122. Entities 122 may be earth entities such as wells, surfaces, reservoirs, etc. In the system 100, the entities 122 are typically virtual representations of actual physical entities that are reconstructed for purposes of simulation. The entities 122 may be based on data acquired via sensing, observation, etc. (e.g., the seismic data 112 and other information 114).

As described herein, the simulation component 120 may rely on a software framework such as an object-based framework. In such a framework, entities may be based on pre-defined classes to facilitate modeling and simulation. A commercially available example of an object-based framework is the MICROSOFT® .NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may be a library of attributes. Such processing may occur prior to input to the simulation component 120. Alternatively, or in addition to, the simulation component 120 may perform operations on input information based on one or more attributes specified by the attribute component 130. As described herein, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results. Additionally, or alternatively, output from the simulation component 120 may be input to one or more other workflows, as indicated by a workflow component 144.

As described herein, the management components 110 may include features of a commercially available simulation framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment).

As described herein, the management components 110 may include features for geology and geological modeling to generate high-resolution geological models of reservoir structure and stratigraphy (e.g., classification and estimation, facies modeling, well correlation, surface imaging, structural and fault analysis, well path design, data analysis, fracture modeling, workflow editing, uncertainty and optimization modeling, petrophysical modeling, etc.). Particular features may allow for performance of rapid 2D and 3D seismic interpretation, optionally for integration with geological and engineering tools (e.g., classification and estimation, well path design, seismic interpretation, seismic attribute analysis, seismic sampling, seismic volume rendering, geobody extraction, domain conversion, etc.). As to reservoir engineering, for a generated model, one or more features may allow for simulation workflow to perform streamline simulation, reduce uncertainty and assist in future well planning (e.g., uncertainty analysis and optimization workflow, well path design, advanced gridding and upscaling, history match analysis, etc.). The management components 110 may include features for drilling workflows including well path design, drilling visualization, and real-time model updates (e.g., via real-time data links).

As described herein, various aspects of the management components 110 may be add-ons or plug-ins that operate according to specifications of a framework environment. For example, a commercially available framework environment marketed as the OCEAN® framework environment (Schlumberger Limited) allows for seamless integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. As described herein, various components may be implemented as add-ons (or plug-ins) that conform to and operate according to specifications of a framework environment (e.g., according to application programming, interface (API) specifications, etc.). Various technologies described herein may be optionally implemented as components in an attribute library.

In the field of seismic analysis, aspects of a geologic environment may be defined as attributes. In general, seismic attributes help to condition conventional amplitude seismic data for improved structural interpretation tasks, such as determining the exact location of lithological terminations and helping isolate hidden seismic stratigraphic features of a geologic environment. An attribute generation process (e.g., in the PETREL® framework or other framework) may rely on a library of various seismic attributes (e.g., for display and use with seismic interpretation and reservoir characterization workflows).

In the example of FIG. 1, the linking components 170 include a template generation component 172, a template instantiation component 174 and an analysis component 176. One or more of the linking components 170 can interact with the management components 110. For example, a template generated by the template generation component 172 may be consumed by a realization of a simulation process (e.g., executing per the simulation component 120) for the geologic environment 150 to thereby instantiate the template (e.g., per the template instantiation component 174). As described herein, instantiation of a template can allow for an analysis (e.g., per the analysis component 176) where the analysis relies on data associated with one or more the entities 122. In various examples, instantiation of a template allows for access to instantiated objects. For example, a template may define a business process that relies on information associated with an object such that instantiation of the business process template realizes the business process, which, in turn, accesses information associated with an instantiated object. In the foregoing example, the instantiated object may be one of the entities 122 (e.g., part of a realization of a simulation of a geologic environment).

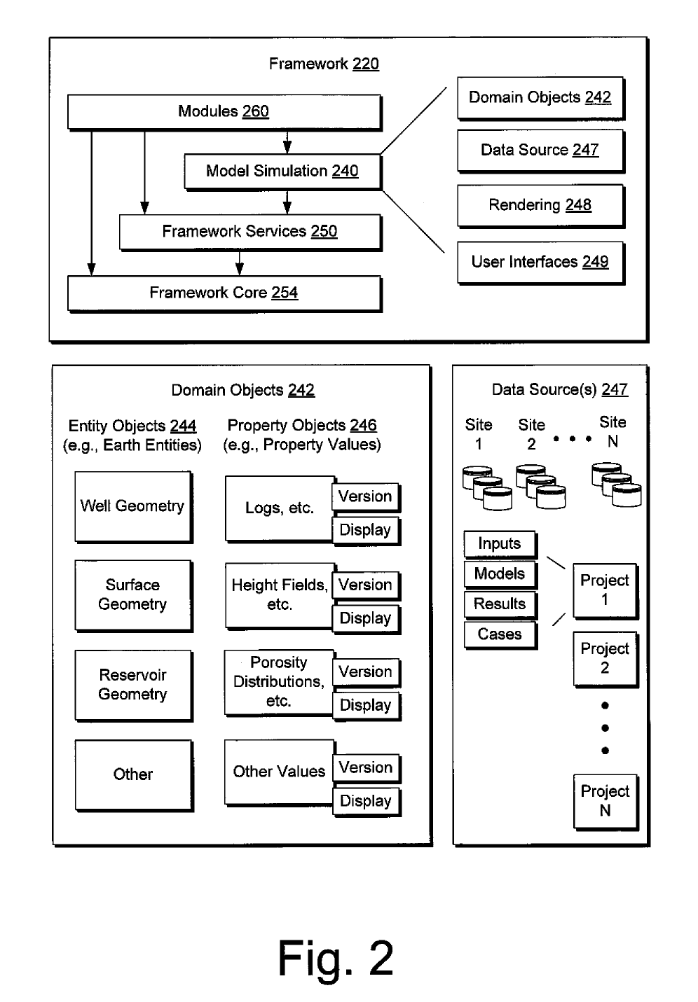

FIG. 2 shows an example of a framework 220 that includes a model simulation 240 layer along with a framework services layer 250, a framework core layer 254 and a modules layer 260. The framework 220 may be the commercially available OCEAN® framework where the model simulation layer 240 is the commercially available PETREL® model-centric software package that hosts OCEAN® framework applications. As described herein, the PETREL® software may be considered a data-driven application.

The model simulation layer 240 may provide domain objects 242, act as a data source 247, provide for rendering 248 and various user interfaces 249. Rendering 248 may provide a graphical environment in which applications can display their data while the user interfaces 249 may provide a common look and feel for all application user interface components.

In the example of FIG. 2, the domain objects 242 include entity objects 244 and property objects 246. The entity objects 244 can be used to geometrically represent wells, surfaces, reservoirs, etc., while the property objects 246 can be used to provide property values as well as data versions and display parameters. For example, an entity object may represent a well where a property object provides log information as well as version information and display information (e.g., to display the well as part of a model).

In the example of FIG. 2, data may be stored in one or more data sources 247 (or data stores, generally physical data storage devices), which may be at the same or different physical sites and accessible via one or more networks. The model simulation layer 240 may be configured to model projects. As such, a particular project may be stored where stored project information may include inputs, models, results and cases. Thus, upon completion of a modeling session, a user may store a project. At a later time, the project can be accessed and restored using the model simulation layer 240, which can recreate instances of the relevant domain objects. For situations where data has been changed, version information may be noted such that a user can determine, for example, whether the current instance of an object representing an earth entity is based on old property values or current property values; noting that a change in property values may alter a model result (e.g., for one or more cases).

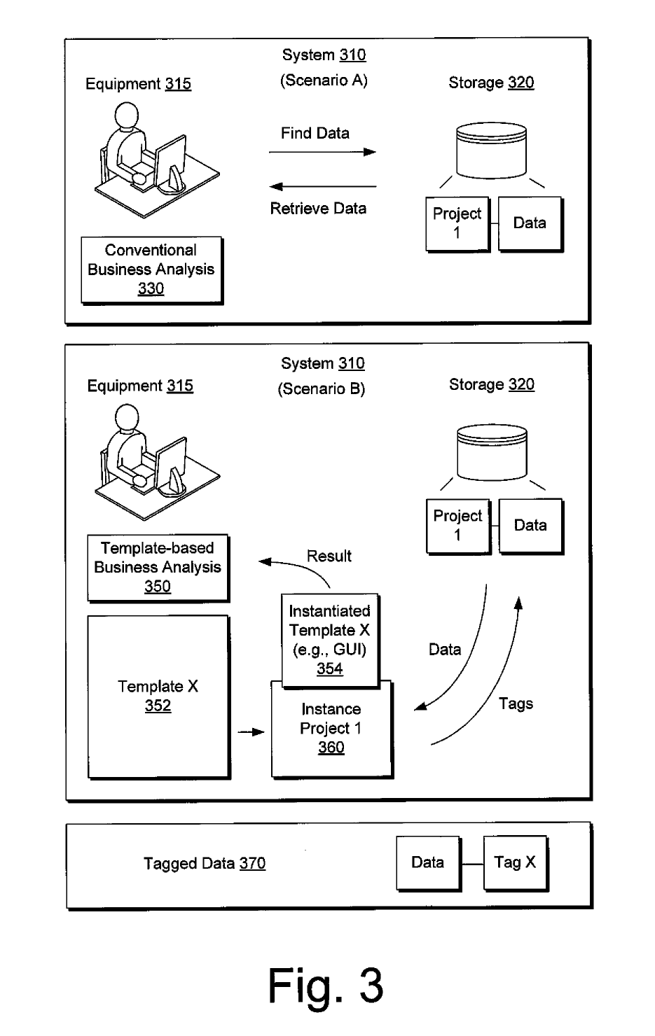

FIG. 3 shows a system 310 for a conventional business analysis 330 (Scenario A) and the system 310 and the system 310 for a template-based business analysis 350 (Scenario B). In Scenario A (conventional), a user operates equipment 315 in the system 310 to find relevant data in a storage 320. For example, the user may desire to assess a chance of success for a reservoir modeled in Project 1 where the reservoir has associated property values. To perform the assessment, the user must identify the property values (e.g., data) for Project 1 and then retrieve the values. Once the values have been retrieved, the user can perform the business analysis 330 to determine the chance of success for the reservoir modeled in Project 1.

In Scenario B (template-based), a user operates equipment 315 in the system 310 to call for instantiation of a template X 352 by an instance of Project 1 360 (e.g., a realization of a data-driven application). The instantiated template X 354 can call for rendering of a graphical user interface (GUI) while Project 1 is running (e.g., per the model simulation layer 240 of FIG. 2). As shown in the example of FIG. 3, the instance of Project 1 360 relies on data in the storage 320. The instantiated template 354 can access (e.g., link to) this data locally (or remotely) for purposes of performing the business analysis 350 defined by the template X 352 (e.g., a chance of success of a reservoir modeled in Project 1).

As shown in the example of FIG. 3, the instantiated template X 354 can also cause data associated with Project 1 to be tagged. For example, where the template-based business analysis 350 relies on porosity distribution data for a reservoir, the instantiated template X 354 may cause data in the storage 320 to be tagged as indicated by tagged data 370. Once tagged, the data can be identified as being associated with the template X (e.g., associated with the business analysis defined by template X). Further, the particular data tagged may include version information such that the business analysis can be reconfirmed or re-performed at a later time using a particular version of data. As described herein, given the approach of Scenario B, a user may identify data across an enterprise for various projects that have been used to perform a business analysis defined by the template X 352 (or any other template configured to cause tagging of data).

In general, a project built using PETREL® software contains so-called data elements that represent earth entities (e.g., a well, a surface, a reservoir, etc.). Earth entities can be characterized by properties (e.g., logs along a well bore, height fields across a surface, porosity distributions in a reservoir, etc.). Earth entities in a data-driven application such as the PETREL® application may be based on domain objects (e.g., consider the entity objects 244 and the property objects 246 of FIG. 2). As described herein, linking may link to entities and tagging may tag entities, which inherently link to data (or “data elements”) and tag data (or “data elements”), respectively, or, for example, linking may link directly to data and tagging may directly tag data. As described herein, linking and tagging may optionally occur in an essentially simultaneous manner (e.g., where a linking operation automatically causes data to be tagged).

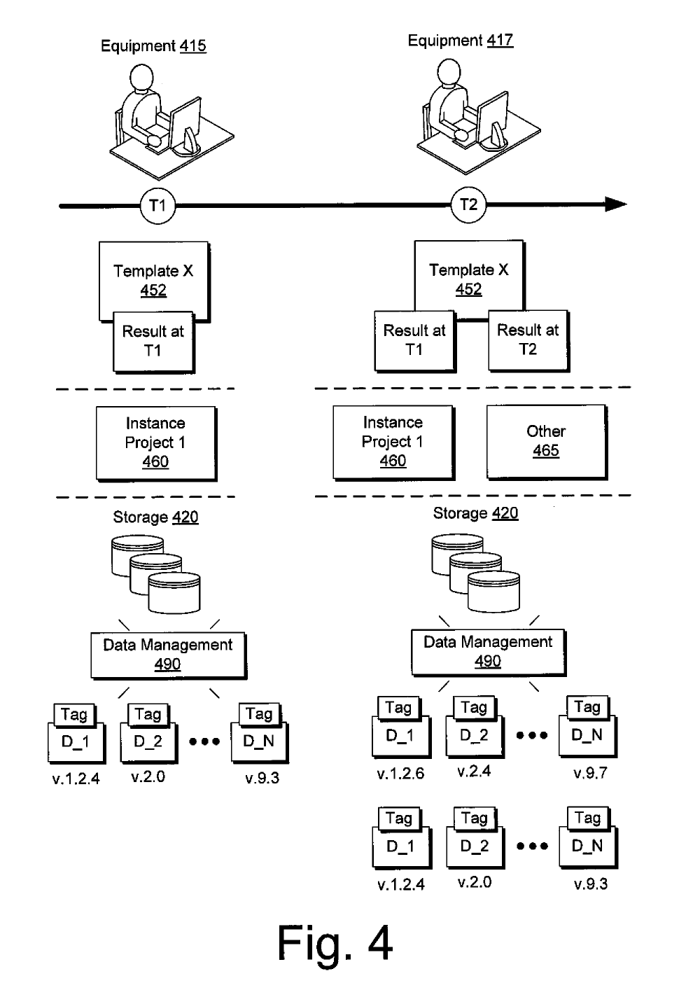

FIG. 4 shows examples at times T1 and T2 for a template-based business analysis. At time T1, a user at equipment 415 performs a template-based business analysis for an instance of Project 1 460 using template X 452 to return a result at T1. By performing this task, in storage 420, data associated with Project 1 is tagged, as indicated by a data management component 490. For example, the template X 452 may call for tagging version 1.2.4 of data D_1, version 2.0 of data D_2 and so forth to D_N.

At time T2, a user at equipment 417 performs a template-based business analysis for Project 1 as defined by the template X 452. As the data for Project 1 has already been tagged at time T1 as being associated with the template X 452, the user may optionally perform the analysis in an alternative manner 465 that does not require a running instance of Project 1 460. Further, as indicated in the example of FIG. 4, the user may call for replicating the prior result attained at time T1 or the user may call for generating a new result for time T2. To replicate the result at time T1, the user can identify the previously tagged data as associated with the template X 452 whereas to generate a new result for time T2, the user may instantiate the template X 452 and thereby cause the data to be tagged for time T2 (e.g., with current versions of the data for situations where underlying data may have changed).

While the examples of FIGS. 3 and 4 have been described in association with a business analysis, a field analysis may be implemented in a similar manner. For example, a field engineer may define an engineering process for a field operation via a template. In such an example, instantiation of the template can provide for access to data of a realization of a geologic environment of interest. Given a template defined analysis as output, the field engineer may make a decision, essentially in real-time, as to the field operation. For a field process, tagging may occur to allow for post-analysis of a field decision (e.g., consider a field operation audit).

As described herein, information associated with implementation of a business analysis, a field analysis, etc., may be used as feedback to improve data, data management, business decision making, field decision making, etc. (see, e.g., feedback block 160 of FIG. 1).

As described herein, a domain specific language (DSL) may be used for expressing a process such as a business analysis process that may include determining a probable success or failure. A DSL may be dedicated to a particular problem domain, a particular problem representation technique, a particular solution technique, etc. DSLs are generally implemented either by interpretation or code generation. Interpretation can include reading in the DSL script and executing it at run time. Code-generation can include parsing DSL script and generating code (e.g., in a high level language, such as Java or C). A software process being used generally requires some modification to account for design, implementation, integration, debugging, and maintenance of a DSL. As described herein, a simulation component (e.g., the simulation component 120 of FIG. 1, the simulation layer 240 of FIG. 2, etc.) may include one or more features for handling a DSL script. In a so-called piggyback arrangement, DSL script may be consumed by a component that generates code in a language used by a software package. In turn, the generated code can be executed using the same infrastructure as the software package. In various arrangement, one or more application programming interfaces (APIs) may be provided for interactions between DSL features and features of a software package. Actual implementation of DSL script may include one or more of parsing, interpretation, compilation, etc. An intermediate language may be used where the DSL script is converted to intermediate language code and optionally integrated with other intermediate language code prior to execution.

Below is an example of some DSL script for an analysis template:

define AnalysisTemplate(“Chance of Success”)
{

ConfidenceAggregator(MASTER, SOURCE,

Min((“Source presence and quality (organic quantity/quality)”),
Min((“Maturation (adequate time, temperature, pressure)”),
(“Expulsion”)))),

ConfidenceFactorDefinition(SOURCE, “Source presence and
quality”),
ConfidenceFactorDefinition(SOURCE, “Maturation”),
ConfidenceFactorDefinition(SOURCE, “Expulsion”),
ConfidenceAggregator(MASTER, TRAP,

Min((“Structural Stratigraphic Closure”),
Min((“Seal Continuity and Capacity - top, bottom, & lateral”),
(“Faults or fractures seal”)))),

ConfidenceFactorDefinition(TRAP, “Structural / Stratigraphic
Closure”),
ConfidenceFactorDefinition(TRAP, “Seal Continuity and Capacity ”),
ConfidenceFactorDefinition(TRAP, “Faults or fractures seal”),
ConfidenceAggregator(MASTER, “Chance of Success”,
(SOURCE)*(TRAP)

}

As described herein, a process (e.g., business, field, etc.) can be documented as a template for association with a simulation application. As mentioned, data relied on by the application can be associated with one or more templates. The association between data and a template can result in the data being tagged with one or more tags defined by the template. As such data is typically associated with an earth entity of a project, tagging may optionally be considered as tagging the earth entity. As described herein, tagging may tag geometry data, property value data, or other data. Tagging enables search mechanisms to report data associated with a processes or parts of a process.

In the context of a geoscience repository (e.g., data store), a business analysis is conventionally performed separately (i.e., not in direct association with a realization of simulation of a geologic environment). As described herein, by performing a business analysis within the context of a geoscience repository allows for directly linking data to the analysis and tagging data by the analysis where the tagging can be performed in a manner consistent across multiple repositories (e.g., realizations of different geologic environments) to enable search tools to provide a consistent view over multiple repositories tailored to the business analysis.

As mentioned, implementation of an analysis can provide for an audit trail associated with a geoscience repository in a manner that also enables a consistent methodology of geoscience analysis across an organization or group of users.

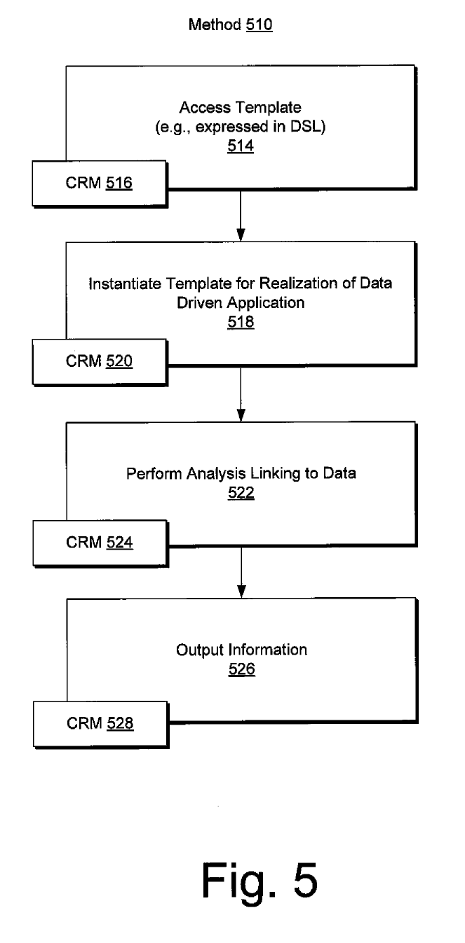

FIG. 5 shows an example of a method 510. The method 510 includes an access block 514 for accessing a business analysis template expressed in a domain specific language (DSL), an instantiation block 518 for instantiating the template for a realization of a geoscience application configured to accesses data associated with a geological field, a performance block 522 for performing a business analysis where the performing includes linking to particular data associated with the geological field based at least in part on the template, and an output block 526 for outputting information based at least in part on the analysis.

The method 510 is shown in FIG. 5 in association with various computer-readable media (CRM) blocks 516, 520, 524 and 528. Such blocks generally include instructions suitable for execution by one or more processors (or cores) to instruct a computing device to perform one or more actions. While various blocks are shown, a single medium may be configured with instructions to allow for, at least in part, performance of various actions of the method 510.

As described herein, a method can include accessing a template, instantiating the template for a realization of a data-driven application, performing an analysis defined by the template where the analysis relies on linking to at least some data relied on by the data-driven application and outputting information based at least in part on the analysis. As described herein, one or more computer-readable media can include instructions to instruct a computing system to access a template, instantiate the template for a realization of a data-driven application, perform an analysis defined by the template where the analysis relies on linking to at least some data relied on by the data-driven application and output information based at least in part on the analysis.

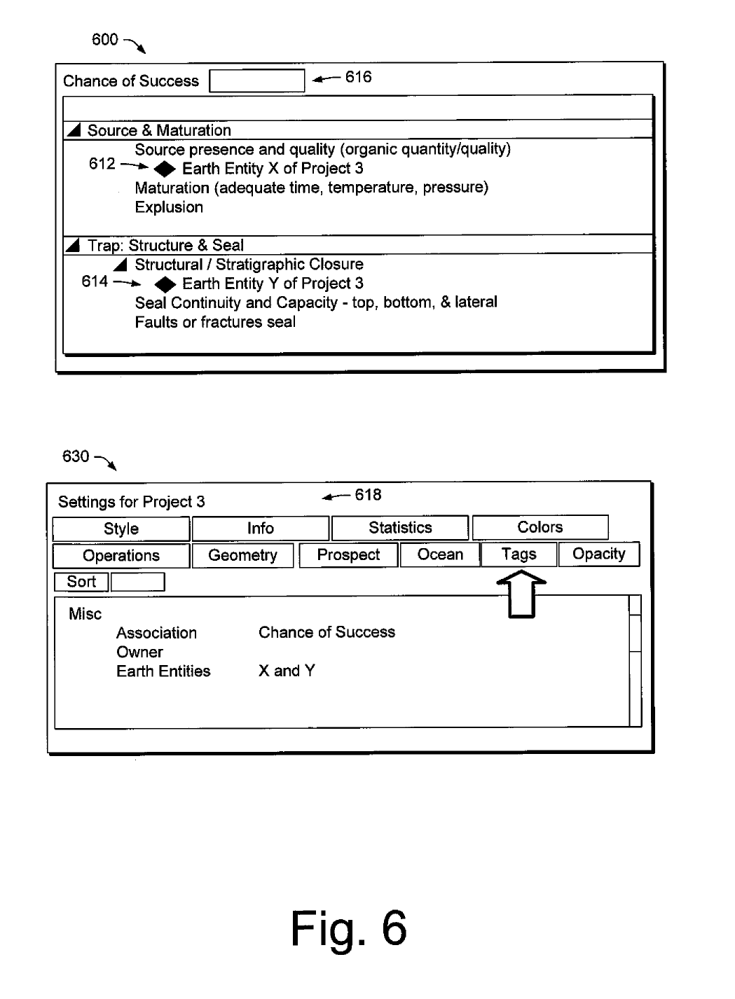

FIG. 6 shows an example of implementation of the method 510 of FIG. 5 within a framework such as the PETREL® framework (noting a method may be implemented in other types of frameworks). FIG. 6 shows an example of a graphical user interface (GUI) 600 that aims to correspond to the previously described example DSL script. Such a GUI may be part of a client defined analysis and used during analysis of a project. Specifically, the GUI 600 may be a realization of a business process from a template where the GUI 600 is presented to a user via user equipment within a geoscience project of a geoscience application framework.

In the example of FIG. 6, the GUI 600 pertains to an assessment that involves calculating a chance of success based on a variety of geoscience factors. As part of the assessment, geoscience workflows and products generated by the geoscience application can be collated and directly related to the chance of success factors.

As different organizations are likely to require a different combination of factors depending on their respective business model and the geography and geology of a project being assessed, the process is presented as a template that can be created and customized by a client organization. Again, as mentioned, such a template can be expressed via a DSL.

As indicated in FIG. 6, data items from the geoscience project can be directly linked to the business process, to document which geoscience data items were used to assess factors in the process. In the example of FIG. 6, the business process reflects that geoscience objects have been used to asses “Source presence and quality” and “structural/stratigraphic closure”. Specifically, in the GUI 600 filled diamonds represent objects 612 (“Earth Entity X of Project 3”) and 614 (“Earth Entity Y of Project 3”). These entities from the geoscience application are now linked with the business process. In various examples, a suggestion may be presented to a user via a GUI as to what entity is available and suitable for a defined business process. Such a GUI may optionally allow a user to modify the business process based on one or more suggestions.

FIG. 6 also shows an example GUI 630 to further describe some aspects of tagging. Specifically, in the example of FIG. 6, the GUI 630 pertains to the entities 612 and 614 (e.g., Earth Entities X and Y of Project 3).

The tagging then enables data to be viewed in relationship with the process. For example, a GUI may show all data in a geoscience repository connected to an entity. Tagging can also enable the business process to control the display style of an entity when visualized in the geoscience application (see, e.g., the property objects 246 with display parameters of FIG. 2).

In the example of FIG. 6, the tagging of data is controlled by the business process. Accordingly, all geoscience repositories that use the same business process template can generate the same set of tags, which can enable a consistent view, ability to search, etc., across multiple projects.

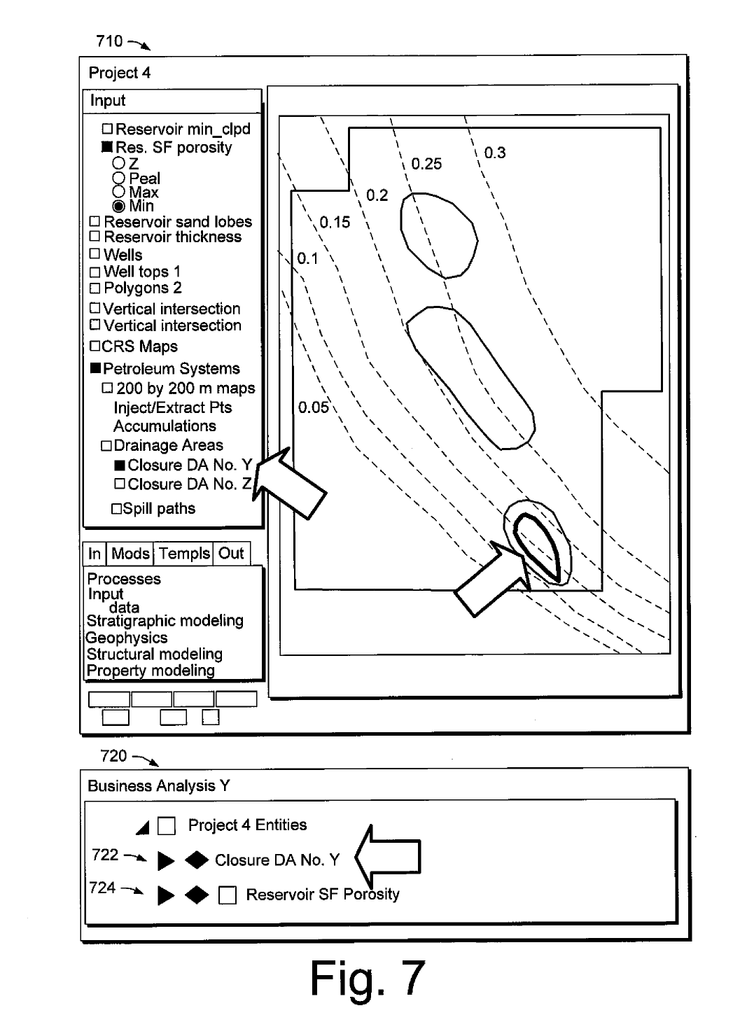

FIG. 7 shows examples of interfaces associated with an example implementation within a framework such as the PETREL® framework. FIG. 7 shows an example of a GUI 710 for Project 4 with an earth entity outlined by a thick solid line referred to as “Closure DA No. Y” (e.g., see arrows). A GUI 720 exposes the entities 722 (“Closure DA No. Y”) and 724 (“Reservoir SF Porosity”) as being tagged. The GUI 720 presents a dropped sub-heading for at least some earth entities of Project 4.

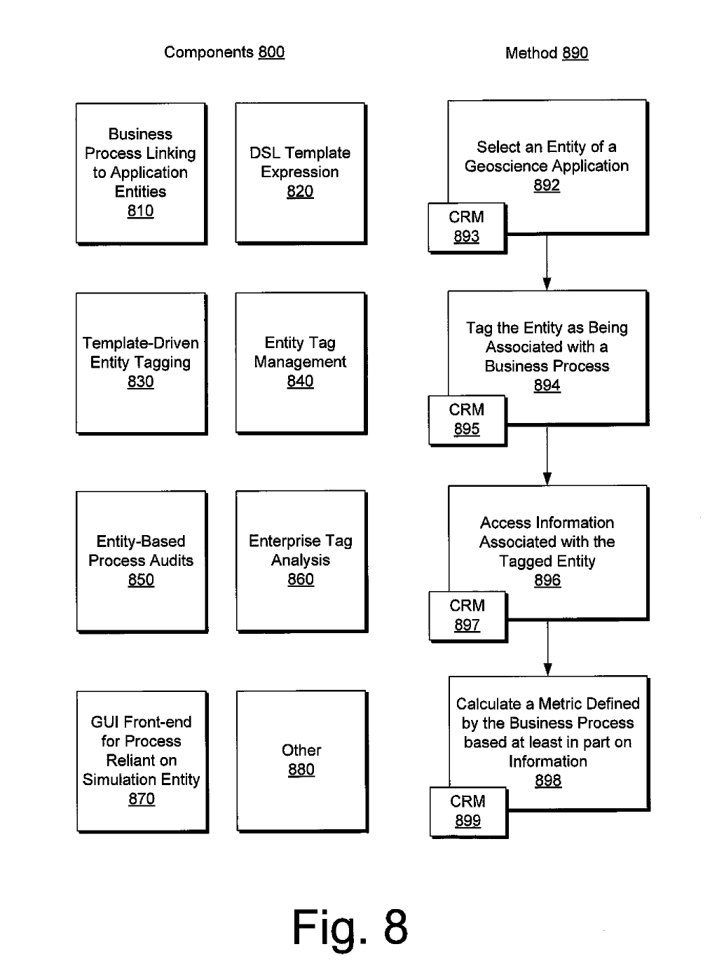

FIG. 8 shows examples of various modules or components 800, which may be configured for implementation by a computing device or system, and an example of a method 890. As shown in FIG. 8, a linking component 810 may be configured for linking a business analysis (or process) to entities (e.g., objects, data, etc.) associated with an application such as a geoscience application. Such a component may provide for a GUI associated with a business process where the GUI displays one or more entities of an application, optionally in response to receipt of user input.

A DSL template expression component 820 may be configured for receiving user input to enter or select statements of a DSL where the statements collectively form a template that can be instantiated, for example, by an application such as a geoscience application.

A template-driven entity tagging component 830 may be configured for tagging entities associated with an application such as a geoscience application. For example, a template may be instantiated by a realization of a geologic environment by a geoscience application where a GUI is rendered to a display that allows for display of entities of the geoscience application (e.g., entities as instantiated by the realization). In such a manner, a process (e.g., a business process or field process) may perform an analysis using information associated with the entities.

An entity tag management component 840 may be configured for managing entity tags. For example, a business process may tag various entities associated with a realization of a geologic environment by a geoscience application. In such an example, the entities may be agnostic to the particular geologic environment realized. The entities may be managed based on status (e.g., tagged or not tagged). Management may include updates to tags for various projects responsive to changes in underlying data or decisions.

An entity-based process audit component 850 may be configured for auditing processes. For example, a business process may rely on one or more entities of a geoscience application where during the process tagging of the entities occurs. If the business process results in a business decision, that decision may be audited at a later time by examining the tagged entities (e.g., and associated data).

An enterprise tag analysis component 860 may be configured to analyze tags or tagged entities across an enterprise (e.g., including partners, contractors, suppliers, etc.). Where application entities are tagged as part of a business process, decision making based on such business processes may be analyzed across an enterprise, for example, to determine key information or trends in decision making (e.g., in view of new information, training, etc.). Decisions that were deemed adequate at one point in time may be analyzed to determine if they are still adequate at a later point in time. Tagged entities may be examined to determine what is leading to a changed result.

A GUI front-end component 870 may be configured to implement a process (e.g., business process or field process) that relies on one or more entities associated with simulation software for simulating a physical environment. For example, a GUI may present a business process in conjunction with earth entities associated with simulation software whereby a user may selectively activate a graphic control to select one or more of the entities to thereby access data for use in the business process. The GUI component 870 may be configured to access a library of entities to allow for automatic population of selection options for a business process. In a particular approach, the GUI component 870 may be instantiated via consumption of a template expressed in a DSL (e.g., where the DSL is specific to a process such as a business process and an application such as a geoscience application).

The components 800 include a component 880, which may include one or more features of the components 810 to 870 and optionally other features.

In the example of FIG. 8, the method 890 includes a selection block 892 for selecting an entity of a geoscience application, a tag block 894 for tagging the entity as being associated with a business analysis (e.g., a business process), an access block 896 for accessing information associated with the tagged entity; and a calculation block 898 for calculating a metric defined by the business analysis (e.g., business process) based at least in part on information. As shown in FIG. 8, one or more computer-readable media can include computer-executable instructions to instruct a computing system to select an entity of a geoscience application 893, tag the entity as being associated with a business analysis (e.g., a business process) 895, access information associated with the tagged entity 897; and calculate a metric defined by the business analysis (e.g., business process) based at least in part on information 899. In the foregoing example, an entity may be based on one or more domain objects (e.g., entity objects and property objects). While various blocks are shown in FIG. 8, a single medium (e.g., a storage medium) may be configured with instructions to allow for, at least in part, performance of various actions of the method 890. Such blocks generally include instructions suitable for execution by one or more processors (or cores) to instruct a computing device to perform one or more actions.

As described herein, a method can include selecting an entity of a geoscience application, tagging the entity as being associated with a business process, accessing information associated with the tagged entity; and calculating a metric defined by the business process based at least in part on information. As described herein, one or more computer-readable media can include computer-executable instructions to instruct a computing system to select an entity of a geoscience application, tag the entity as being associated with a business process, access information associated with the tagged entity; and calculate a metric defined by the business process based at least in part on information. In the foregoing example, an entity may be based on one or more domain objects (e.g., entity objects and property objects).

As described herein, a template may be instantiated for a realization of a process, which then will give a link to data associated with an application. A template may define a business process. As described herein, a system may be configured to run a business process that aims to determine one or more metrics as to, for example, a chance of success. Such a system may be configured to run the process over time to see if a chance of success has changed (for better or worse). While various examples refer to “chance of success”, a business process may provide output germane to decisions other than chance of success (or failure).

As described herein, a system may provide for auditing one or more processes based on information extracted during a process run (e.g., business process run X at time t, it is known what entities were relied on and what the underlying data was for the geoscience package at time t per database information, object management, etc.). An audit may provide some confidence of what someone decided and why. For example, for a person that found a 53% chance of success and production of 70 million barrels, if actual production differs when drilled, an update as to underlying business process may occur (e.g., optionally via a modification of a template).

As described herein, where tagging occurs, tagged data may be of interest to managers, scientists and business people. Further, tags may be used in various types of feedback loops. As to managers, data managers may need to store properly tagged data. As to scientists, they may need to know what data is being relied on by business people. As to business people, they may need to know when data is updated and that it has integrity.

As described herein, a system may be configured to allow a user to define a template via a domain specific language, to instantiate the template in a geoscience package to link to data in a manner that involves tagging data relied on by a geoscience package (e.g., to provide for associations with underlying physical data). Such a system may optionally be configured to run a template-defined process over time to see if output changes over time. In various examples, a system may run automatically in response to a trigger. For example, new data or revised data being stored at a storage location may cause a trigger to call for access to one or more business process templates and instantiation of those templates using the new or revised data. Where an outcome differs, an email or other communication may be sent to a user associated with a prior business process run to notify that user that circumstance have changed in a manner whereby the outcome of the business process differs. In such an example, a user may be able to set one or more parameters as to what type of difference would be sufficient for issuing a notification (e.g., +10%, −10% or +/−10%).

As described herein, one or more computer-readable media may include computer-executable instructions to instruct a computing system to output information for controlling a process. For example, such instructions may provide for output to sensing process, an injection process, drilling process, an extraction process, etc.

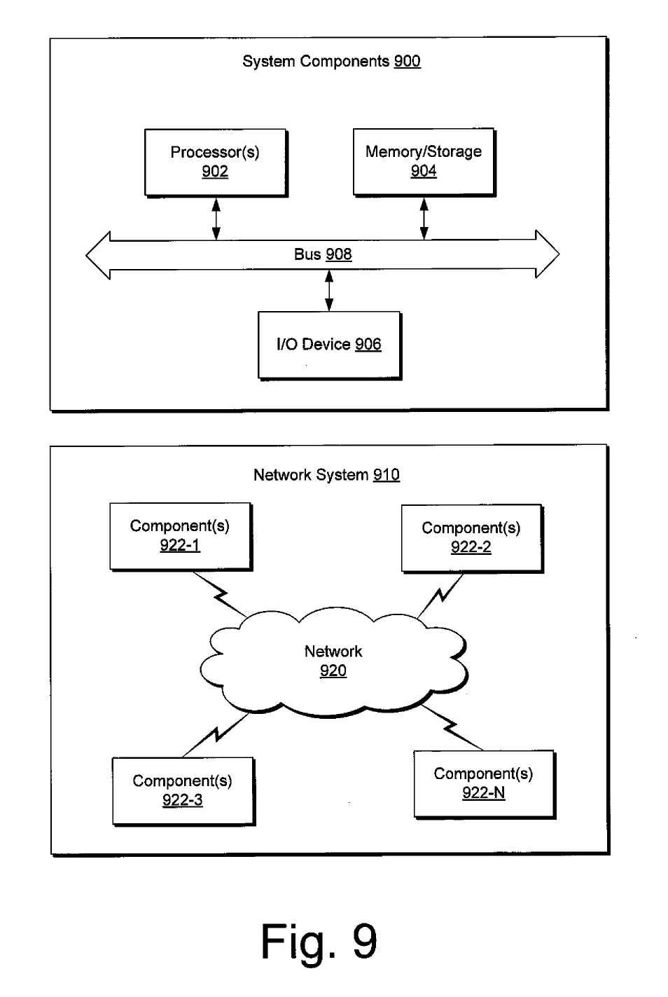

FIG. 9 shows components of a computing system 900 and a networked system 910. The system 900 includes one or more processors 902, memory and/or storage components 904, one or more input and/or output devices 906 and a bus 908. As described herein, instructions may be stored in one or more computer-readable media (e.g., memory/storage components 904). Such instructions may be read by one or more processors (e.g., the processor(s) 902) via a communication bus (e.g., the bus 908), which may be wired or wireless. The one or more processors may execute such instructions to implement (wholly or in part) one or more attributes (e.g., as part of a method). A user may view output from and interact with a process via an I/O device (e.g., the device 906). As described herein, a computer-readable medium may be a storage component such as a physical memory storage device, for example, a chip, a chip on a package, a memory card, etc.

As described herein, components may be distributed, such as in the network system 910. The network system 910 includes components 922-1, 922-2, 922-3, . . . 922-N. For example, the components 922-1 may include the processor(s) 902 while the component(s) 922-3 may include memory accessible by the processor(s) 902. Further, the component(s) 902-2 may include an I/O device for display and optionally interaction with a method. The network may be or include the Internet, an intranet, a cellular network, a satellite network, etc.

### CONCLUSION

Although various methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

1. One or more computer-readable media comprising computer-executable instructions to instruct a computing system to:
access a template;
instantiate the template for a realization of a data-driven application;
perform an analysis defined by the template wherein the analysis relies on linking to at least some data relied on by the data-driven application; and
output information based at least in part on the analysis.

2. The one or more computer-readable media of claim 1 further comprising computer-executable instructions to instruct a computing system to instantiate the template by interpreting statements written in a domain specific language.

3. The one or more computer-readable media of claim 1 further comprising computer-executable instructions to instruct a computing system to tag data relied on by the data-driven application.

4. The one or more computer-readable media of claim 1 further comprising computer-executable instructions to instruct a computing system to render a graphical user interface with a graphical control for selection of an entity of the data-driven application.

5. The one or more computer-readable media of claim 4 further comprising computer-executable instructions to instruct a computing system to receive a selection command for selection of an entity.

6. The one or more computer-readable media of claim 1 wherein the data-driven application comprises a geoscience application.

7. The one or more computer-readable media of claim 1 wherein the template comprises a template expressed in a domain specific language.

8. The one or more computer-readable media of claim 1 wherein the data-driven application comprises a geosciences application for modeling a reservoir and wherein the template defines a business process that includes the analysis as an indicator of economic viability of a reservoir.

9. The one or more computer-readable media of claim 8 wherein the indicator of economic viability comprises a chance of success or failure.

10. A method comprising:
accessing a template;
instantiating the template for a realization of a data-driven application;
performing an analysis defined by the template wherein the analysis relies on linking to at least some data relied on by the data-driven application; and
outputting information based at least in part on the analysis.

11. The method of claim 10 wherein the linking comprises tagging at least some of the data with tags.

12. The method of claim 11 further comprising storing the tags.

13. The method of claim 12 further comprising performing an audit of the analysis based at least in part on one or more stored tags.

14. The method of claim 11 wherein the template defines a business process.

15. The method of claim 14 further comprising managing tagged data with respect to versions of the data.

16. The method of claim 10 further comprising managing storage of data based at least in part on the linking.

17. One or more computer-readable media comprising computer-executable instructions to instruct a computing system to:
select an entity of a geoscience application;
tag the entity as being associated with a business process;
access information associated with the tagged entity; and
calculate a metric defined by the business process based at least in part on information.

18. The one or more computer-readable media of claim 17 further comprising computer-executable instructions to instruct a computing system to select the entity based at least in part on instantiation of a template that defines the business process.

19. The one or more computer-readable media of claim 17 wherein the metric comprises a chance of success.

20. The one or more computer-readable media of claim 17 further comprising computer-executable instructions to instruct a computing system to store the tag.
